(19) United States
(12) Patent Application Publication
(10) Pub. No.: US 2025/0163188 A1
(43) Pub. Date: May 22, 2025

(54) METHOD OF EXTRACTION OF CHITIN FROM BIOMASS

(71) Applicants: Audrey MOORES, Montreal (CA); Juliana VIDAL, Montreal (CA); Faezeh HAJIALI, Burnaby (CA); Luis DE LA GARZA, Saint-Leonard (CA)

(72) Inventors: Audrey MOORES, Montreal (CA); Juliana VIDAL, Montreal (CA); Faezeh HAJIALI, Burnaby (CA); Luis DE LA GARZA, Saint-Leonard (CA)

(21) Appl. No.: 18/841,059

(22) PCT Filed: Mar. 10, 2023
(86) PCT No.: PCT/CA2023/050321

§ 371 Date: Aug. 23, 2024

Related U.S. Application Data
(60) Provisional application No. 63/319,111, filed on Mar. 11, 2022.

(51) Int. Cl. C08B 37/08; C08B 37/00

(52) U.S. Cl. CPC C08B 37/003; C08B 37/0003

(57) ABSTRACT

The present technology relates to methods of extraction of chitin from chitin-containing biomass using mechanochemistry. Specifically, the methods disclosed comprise milling the chitin-containing biomass with an acid to obtain chitin. The chitin obtained by the milling step is demineralized and deproteinized in a single step. The present technology provides a greener, milder, and more sustainable approach for the extraction of chitin from chitin-containing biomass, while providing high yields of extraction and high purity of chitin.

### TECHNICAL FIELD

The present technology relates to methods of extraction of chitin from chitin-containing biomass using mechanochemistry.

### BACKGROUND

Biopolymers are triggering intense research interests for they are envisaged as renewable sources for materials and molecules. Chitin in particular is the second most abundant naturally synthesized polymer with yearly production levels in the billions of tons.

Chitin is a natural polysaccharide composed of β-(1-4)-linked 2-deoxy-2-acetamido-D-glucose units. Its amide functionality constitutes an interesting manifold for functionalization and applications. Moreover, owing to its antimicrobial activity, chitin has potential applications in food industry, pulp and paper, water treatment, cosmetics, and biomedicine.

Natural sources of chitin (or chitin-containing biomass) include crustacean shells which are produced at around 6 to 8 million tons annually. These resources however are generally discarded by seafood industries; thereby creating undesirable landfilled crustacean wastes which are expensive to dispose of, and cause environmental issues, strong odor during decomposition, and provide human health risks.

Chitin in such chitin-containing biomaterials generally exists in composite form, and in association with proteins and minerals such as calcium carbonate. To isolate chitin from such biomaterials the steps of deproteinization, demineralization, and bleaching (depigmentation) are necessary to obtain pure colorless chitin. Since the chitin-containing biomaterial, such as crustacean shells, have poor solubility in water due to their chitin-calcium carbonate-protein matrix, harsh chemicals and elevated temperatures have been traditionally employed for the extraction of chitin resulting in the release of corrosive effluents into the environment. Specifically, in the deproteinization step, proteins are removed by heating with basic solutions such as KOH and NaOH. In the demineralization step, minerals such as calcium carbonate are removed from the exoskeleton using concentrated inorganic or organic acids (FIG. 1). Lastly, to remove the organic pigments, the product is decolorized/bleached using acetone or hydrogen peroxide to yield colorless chitin for industrial applications.

As can be seen in FIG. 1, summarizing the existing methods of chitin extraction, the traditional chemical methods require long reaction periods and elevated temperatures, which are energy-consuming processes. Additionally, the corrosive effluents must be neutralized and detoxified before disposal as they contain concentrated acids and bases, thus increasing the production cost.

Several other strategies have aimed to tackle these problems to offer alternative methods of extraction, such as by using glycerol, ionic liquids, enzymatic techniques, and bacterial fermentation methods (summarized in FIG. 1). However, these methods have not been effective at industrial scales and to this day the chemical extraction of crustacean shells is still preferred in industrial settings due to its simplicity and relatively lower residual impurities (proteins and minerals).

Therefore, there is a need for alternative or improved methods of chitin extraction which overcome or reduce at least some of the above-described problems.

### SUMMARY

From a broad aspect, there present technology relates to methods of extraction of chitin from chitin-containing biomass using mechanochemistry.

From one aspect, the present technology relates to methods of extraction of chitin from chitin-containing biomass and comprise milling the chitin-containing biomass with an acid to obtain chitin, wherein the chitin obtained by the milling step is demineralized and deproteinized.

From another aspect the present technology relates to methods of extraction chitin from chitin-containing biomass which consist of milling the chitin-containing biomass with an acid to obtain chitin, wherein the chitin obtained by the milling step is demineralized and deproteinized.

From a further aspect, the present technology relates to methods of producing deproteinized and demineralized chitin which comprise of milling a chitin-containing biomass with an acid.

From yet another aspect, the present technology relates to methods of producing deproteinized and demineralized chitin which consist of milling a chitin-containing biomass with an acid.

In some aspects, the methods of the present technology conserve the natural environment by using natural resources such as chitin-containing wastes to extract chitin, and mitigate the environmental impact of existing methods of chitin extraction by providing methods which use minimal solvent, energy and create minimal effluents.

In some aspects, the methods of the present technology demineralize and deproteinize chitin in a single step.

In some aspects, the methods of the present technology are scalable.

In some aspects, the methods of the present technology are sustainable.

In some aspects, the methods of the present technology are performed in solid-state, wherein the milling step is performed in the absence of water.

In some aspects, the methods of the present technology produce intact chitin at high yields, and with high purity.

### BRIEF DESCRIPTION OF THE DRAWINGS

Reference will now be made to the accompanying drawings.

FIGS. 1A-1D are schematic illustrations of methods of extraction of chitin from green crab shells using (A) a traditional chemical process according to Abdou, E. S. et al., “Extraction and characterization of chitin and chitosan from local sources”, Bioresource Technology, 2008, 99 (5), 1359-1367, the content of which is incorporated herein by reference; (B) ionic liquids according to Setoguchi, T. et al., “Facile production of chitin from crab shells using ionic liquid and citric acid”, International Journal of Biological Macromolecules, 2012, 50 (3), 861-864, the content of which is incorporated herein by reference; (C) a bacterial fermentation method according to Ghorbel-Bellaaj, O. et al., “Chitin extraction from shrimp shell waste using Bacillus bacteria”, International journal of biological macromolecules, 2012, 51 (5), 1196-1201, the content of which is incorporated herein by reference; and (D) methods according to certain embodiments of the present technology.

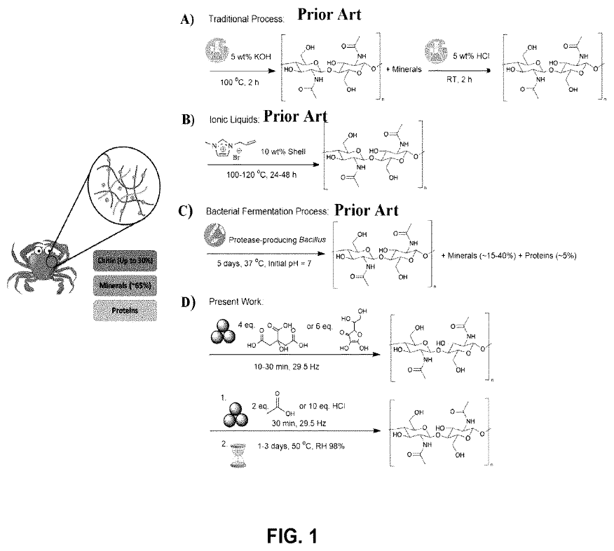

FIGS. 2A-2C are graphs illustrating (A) pXRD pattern of raw GC shells, chitin isolated by the legacy method and commercially available PG chitin (CH: chitin, Ca: calcite); (B) TGA analysis; and (C) ¹³C SS-NMR of raw GC shells, deproteinized GC and chitin from the legacy method.

FIG. 3 is a general scheme of the extraction of chitin from GC shells according to certain embodiments of the present technology.

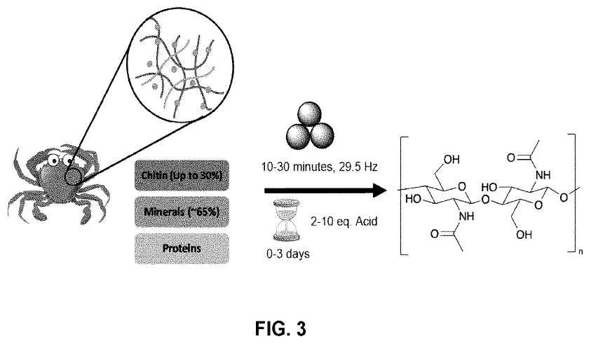

FIGS. 4A-4C are graphs illustrating (A) pXRD pattern; (B) TGA analysis of GC shells milled by 2 & 4 equivalents citric acid; and (C) ¹³C SS-NMR of chitin extracted by milling with 4 equivalents citric acid.

FIGS. 5A-5D are graphs illustrating (A) pXRD; (B) TGA; (C) mineral content for demineralized GC shells using 2, 4, and 6 equivalents ascorbic acid; and (D) ¹³C SS-NMR of chitin extracted by milling with 6 equivalents of ascorbic acid.

FIGS. 6A-6D are graphs illustrating (A) pXRD; (B) TGA; (C) mineral content and η values for demineralized GC shells using hydrochloric acid (HCl) at different ratios and aging conditions as indicated; and (D) ¹³C SS-NMR of chitin extracted by milling with 10 equivalents of HCl and aging for 3 days.

FIGS. 7A-7D are graphs illustrating (A) pXRD; (B) TGA; (C) mineral content and η values for demineralized GC shells using acetic acid at different ratios and aging conditions as indicated; and (D) ¹³C SS-NMR of chitin extracted by milling with 10 equivalents of citric acid and 2 equivalents of acetic acid and aging for 1 day.

FIGS. 8A and 8B are graphs illustrating (A) TGA, and (B) PXRD of chitin samples extracted from GC shells using 2 equivalents of malic acid, succinic acid and salicylic acid.

FIGS. 9A and 9B are graphs illustrating (A) TGA, and (B) PXRD of chitin samples extracted from GC shells using 1 equivalent of malic acid, succinic acid and salicylic acid.

### DETAILED DESCRIPTION

### Definition

The use of “including”, “comprising”, or “having”, “containing”, “involving” and variations thereof herein, is meant to encompass the items listed thereafter as well as, optionally, additional items. In the following description, the same numerical references refer to similar elements.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

The recitation herein of numerical ranges by endpoints is intended to include all numbers subsumed within that range (e.g., a recitation of 1 to 5 includes 1, 1.25, 1.33, 1.5, 2, 2.75, 3, 3.80, 4, 4.32, and 5).

As used herein, the term “biomass” refers to an organic resource of material of biological origin.

As used herein, the term “chitin-containing biomass” refers to biomass rich in chitin, examples of which will be discussed further below.

As used herein, the term “milling” refers to the process of grinding, cutting, mixing, pressing or crushing a material.

As used herein, the term “sustainable” refers to a technology having a low short-term and long-term impact on the environment.

As used herein, the expression “green” refers to a technology which helps resolve or mitigate environmental impacts and/or conserves the natural environment and resources.

As used herein, the term “mechanochemistry” refers to the use of mechanical milling or shear to induce chemical reactions.

As used herein, the term “chitin” refers to a long chain polymer of N-acetylglucosamine, an amide derivative of glucose.

As used herein, the expression “intact chitin” refers to a chitin molecule having a long or preserved chain structure.

As used herein, the expression “pure chitin” refers to chitin that is substantially free of other components such as proteins and minerals with which chitin is associated in biomass materials. In most arthropods, for example, chitin is often modified, occurring largely as a component of composite materials, such as in sclerotin, a tanned proteinaceous matrix, which forms much of the exoskeleton of insects. In the shells of crustaceans and mollusks chitin is combined with calcium carbonate and proteins to form a strong composite. In its pure, unmodified form, however, chitin is translucent, pliable, resilient, and tough.

As used herein the expression “complete” in reference to demineralization and deproteinization refers to a chitin obtained which is substantially free of minerals and/or substantially free of protein.

As used herein the term “substantially” means to a great or significant extent.

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting.

The present technology stems from the discovery by the present inventors of novel methods of chitin extraction from chitin-containing biomass. The inventors have surprisingly discovered that mechanochemistry or milling of chitin-containing biomass with organic or mineral acids leads to the deproteinization and demineralization of chitin and extraction of same in a single step reaction. Methods of the present technology result in the extraction of pure high-grade chitin with ash contents of less than about 0.5% and crystallinities of more than 60%, indicating complete deproteinization and demineralization of chitin from the biomass. The yield of chitin obtained from these methods may be up to about 50% which is significantly higher than known/traditional methods. The methods of the present technology reduce the use of harsh chemicals in comparison to the traditional chemical methods, thereby offering a green and sustainable method of chitin extraction compared to traditional methods.

In one aspect the methods of the present technology comprise milling the chitin-containing biomass with an acid to obtain chitin, wherein the chitin obtained by the milling step is demineralized and deproteinized. In another aspect, the present technology relates to methods of producing deproteinized and demineralized chitin comprising milling a chitin-containing biomass with an acid.

### Chitin-Containing Biomass

Chitin-containing biomass suitable for the methods of the present technology include shells or cuticles of crustaceans, such as shrimps or crabs, arthropods, insects, squids, shellfish, krill, or the like, or fungi, such as mushrooms. In certain embodiments, the methods of the present technology extract chitin from crustacean shells selected from shrimp shells, crab shells, and lobster shells, and combinations thereof.

In certain embodiments, the crab shells are selected from Green Crab shells, and Snow Crab shells, and combinations thereof. In other embodiments, the crab shells are the European Green Crab shells. The European Green Crab is among the ten most unwanted species of the planet and has been recognized as a serious environmental threat. Therefore, from an environmental standpoint, the use and recycling of Green Crabs is of interest. In yet other embodiments, the crab shells are Snow Crab shells. The high content of chitin in Snow Crab shells makes them an especially valuable source of biopolymers, and well-suited for the methods of the present technology.

The chitin-containing biomass or shells may be defleshed and isolated by any method known in the art. In some embodiments, the chitin-containing biomass may be defleshed manually, for example, to isolate the shells, and thawed in boiling water for between about 2 to 15 minutes. The shells can then be dried at room temperature or other suitable temperatures overnight, or for longer durations as needed to dry the shells.

In further embodiments, the dried chitin-containing biomass may be subjected to rough homogenization into powder form prior to use in the present methods. The rough homogenization increases the ease of contact with the acid to promote deproteinization and demineralization. Homogenization of the isolated shells may be performed by using a blender, a rough pulverizer, such as a shredder, a jaw crusher, a gyratory crusher, a cone crusher, a hammer crusher, a roll crusher, a roll mill; a medium pulverizer such as a stamp mill, an edge runner, a cutting/shearing mill, a rod mill, an autogenous mill, or a roller mill. In certain embodiments, the duration of homogenization is such that the biomass is uniformly and finely powdered as a result of the treatment. In some embodiments, the size of particles of the powdered shells is between about 10 μm and about 100 μm. In other embodiments, the size of the particles may be between about 10 μm and about 20 μm, between about 20 μm and about 50 μm, between about 50 μm and about 70 μm, or between about 70 μm and about 100 μm.

The chitin-containing biomass in powder form contains impurities such as protein, phosphoric acid, iron, copper, zinc, molybdenum, silicon, aluminum, calcium, magnesium, potassium, sodium, calcium carbonate and other minerals derived from such raw material.

### Mechanochemistry

Mechanochemistry is currently the topic of intense research effort, in particular for biomass conversion. Mechanochemical methods tackle the issues related to solubility in common solvents, separation or selectivity, while cutting overall effluents and energy demands. Previous methods such as those disclosed in PCT/CA2019/051048 (incorporated herein by reference) use mechanochemistry together with aging to deacetylate chitin and to thereby produce chitosan. Such methods for example include amorphizing chitin-containing powdered shells for 30 min in ZrO₂ jar with ZrO₂ ball, immediately mixing and milling the amorphized shells with NaOH, and aging to yield deacetylated chitosan. Other methods, such as those disclosed in EP 3 450 462 (incorporated herein by reference) use mechanochemistry to produce chitin oligomers typically containing about two to seven N-acetylglucosamine (NAG) molecules (monomers), NAG, and a 1-O-alkyl-N-acetylglucosamine (methanolysis product and NAG derivative) from chitin-containing biomass through a hydrolysis reaction of chitin by pulverizing the chitin-containing biomass with a pulverization apparatus in the co-presence of water and an acid catalyst selected from phosphoric acid, nitrous acid, and an organic acid. To date, however, the use of mechanochemistry in the extraction of intact chitin having a long or preserved chain structure from chitin-containing biomass has not been explored.

In certain embodiments, mechanochemistry is performed by milling the chitin-containing biomass with an acid. Surprisingly, compared to the traditional methods of extraction, as discussed above, the methods of the present technology result in the extraction/production of deproteinized and demineralized chitin by milling with an acid only, thereby reducing the time needed to extract chitin, the number of chemicals and/or solvents used in the reaction and the resultant release of corrosive effluents into the environment. Therefore, in certain embodiments, the methods of the present technology are said to comprise a single step.

In certain embodiments, the milling step is performed in solid state, using a solid acid. In other words, the milling is performed in the absence of solvents, such as water.

In other embodiments, the milling step may be performed in the presence of a liquid. This technique is also known as liquid-assisted grinding (LAG). According to the definition of LAG, mechanochemical reactivity is affected by the ratio (η) of the liquid additive relative to the weight of solids. In this definition, LAG lies in the range of η≈0-1 μL/mg, while η>10 μL/mg corresponds to a typical solution reaction, and 1<η<10 μL/mg indicates slurry reactions. In certain implementations of these embodiments n may be between about 0.2 μL/mg and about 5 μL/mg. In other embodiments, n may be between about 0.2 μL/mg and about 1.0 μL/mg, between about 0.5 L/mg and about 1.5 μL/mg, between about 1.0 μL/mg and about 2.0 μL/mg, between about 2.0 μL/mg and about 3.0 μL/mg, between about 3.0 μL/mg and about 4.0 μL/mg, or between about 4.0 μL/mg and about 5.0 μL/mg. In one embodiment, n is between about 0.42 μL/mg and about 2.12 μL/mg. In other embodiments, η may be about 0.2 μL/mg, about 0.4 μL/mg, about 0.6 μL/mg, about 0.8 μL/mg, about 1.0 μL/mg, about 1.5 μL/mg, about 2.0 μL/mg, about 2.5 L/mg, about 3.0 μL/mg, about 3.5 μL/mg, about 4.0 μL/mg, about 4.5 μL/mg, or about 5.0 μL/mg.

In certain embodiments, the acid used in the milling step may be an organic acid. Organic acids are especially suited in the methods of the present technology as they can be produced from low-cost biomass, are less harmful to the environment, and the resulting organic salts derived by their use from the present methods have the potential to be reused as environmentally friendly de-icing agents or preservatives. Organic acids used in the methods of the present technology may be selected from citric acid, ascorbic acid, acetic acid, L-malic acid, succinic acid, salicylic acid, L-lactic acid, formic acid, benzoic acid, and glutaric acid and combinations thereof. In certain embodiments, the organic acid is selected from citric acid, ascorbic acid, acetic acid, L-malic acid, succinic acid, and salicylic acid, and combinations thereof.

In further embodiments, the organic acid may be selected from L-malic acid, succinic acid, and salicylic acid, and combinations thereof. Advantageously, L-malic acid, succinic acid, and salicylic acid are available in nature, can be obtained at low costs, and are categorized as green chemicals according to the GSK's acid and base guide (Henderson, R. K. et al., “Development of GSK's acid and base selection guides”, Green Chem. 2015, 17 (2), 945-949, incorporated herein by reference). Similarly, succinic acid is a valuable building block found in nature that can be applied as a precursor for surfactants, solvents, synthetic resins, and pharmaceuticals. Currently, much of its global production relies on a fossil-based route, using non-renewable feedstocks. However, efficient, sustainable, bio-based, and cost-competitive alternative processes for the production of succinic acid are being developed and optimized. Salicylic acid is also naturally synthesized by plants and it is an important hormone for their growth and development. Industrially, salicylic acid is used as a food preservative, bactericide, antiseptic, and starting material for the synthesis of important pharmaceuticals.

In other embodiments, the acid used in the milling step may be a mineral acid. Mineral acids suitable for the methods of the present technology are mild mineral acids such as hydrochloric acid, nitric acid, perchloric acid, sulfuric acid, and phosphoric acid and combinations thereof. In certain embodiments, the mineral acid is hydrochloric acid.

In certain embodiments, the amount or ratio of acid used in the milling step is calculated with respect to a mineral content, and more specifically, the calcium carbonate (CaCO₃) content, in the chitin-containing biomass. In some embodiments, the ratio of acid to the mineral content of the chitin-containing biomass is between about 2:1 and about 10:1. In other embodiments, the ratio of acid with respect to the mineral content in the chitin-containing biomass is 2:1, 3:1, 4:1, 5:1, 6:1, 7:1, 8:1, 9:1, or 10:1.

In any of the embodiments of the present technology milling may be performed by using any one or more of a mixer mill, a ball mill, a planetary mill, a jar with at least one ball, a food processor, a blender, a vortex, a rapid mixer, an extruder, and an acoustic mixer. In certain embodiments, milling comprises using a mixer mill and a jar with at least one ball. In such embodiments, the jar may be made of one or more steel, zirconia and polytetrafluoroethylene (PTFE). The at least one ball may be a zirconia ball, or a steel ball. A combination of balls may also be used, such that at least two balls are used in milling with a jar, wherein the first ball is made of a first material and the second ball is made of a second material. For example, a first zirconia ball and a second steel ball may be used for milling. In other embodiments, the ball may be made of the same material as the jar, such that, for example, a zirconia ball is used in zirconia jar for milling. In other embodiments, the ball may be made of a different material than the jar.

In certain embodiments, milling is performed for about 5 minutes to about 60 minutes. In other embodiments, milling may be performed for about 10 to about 30 minutes, such as for about 15, about 20 or about 25 minutes. In one embodiment, milling is performed for about 30 minutes. In another embodiment, the milling is performed for about 10 minutes. Advantageously, the methods of the present technology use short milling times and thereby decreasing the energy input required to extract chitin from chitin-containing biomass compared to known methods, while still providing high yields and high purities of chitin.

In certain embodiments, the milling is performed at room temperature. Advantageously, this feature also contributes to the green and sustainable characteristics of the methods of the present technology as this limits the energy input required to extract chitin from chitin-containing biomass compared to known methods, as the mixture of chitin-containing biomass and acid does not need to be heated to high temperatures.

### Aging

The methods of the present technology may further comprise an additional step of aging after the step of milling. Accelerated aging by the methods disclosed herewith is considered to be a low energy, solvent-free alternative to solvothermal methods yielding organic and inorganic materials. The inventors of the present technology have found that aging in addition to milling may result in further demineralization of chitin when liquid acids such as hydrochloric acid and acetic acid are used for milling. Aging, however, was not required when milling was conducted with solid acids (i.e., in solid-state). However, an aging step may optionally be added to the methods of the present technology when a solid acid is used.

In certain embodiments, aging may be performed under controlled humidity, with optional heating. In such embodiments, aging may be performed in a humidified chamber, with a relative humidity (RH) of between about 43% to about 98%. In other embodiments, aging may be performed at a RH of about 98%.

Heating may also be performed during the aging step. In certain embodiments heating is performed at temperatures ranging between about 20° C. and about 100° C., such as about 30° C., about 40° C., about 50° C., about 60° C., about 70° C., about 80° C., or about 90° C. In one embodiment, heating is performed at about 50° C. during the aging step.

The duration of aging may range from about 0 to about 6 days depending on the conditions used. In certain embodiments, aging may be performed for 0 days (i.e., no aging may be required). In other embodiments, aging may be performed for about 12 hours to about 6 days. In further embodiments, aging may be performed for about 1 day. In yet further embodiments, aging may be performed for about 3 days.

In certain embodiments, the methods of the present technology comprise milling a chitin-containing biomass selected from any one or more of shells and cuticles of crustaceans, arthropods, insects, squids, shellfish, krill, and fungi with an organic acid selected from citric acid, ascorbic acid, acetic acid, L-malic acid, succinic acid, and salicylic acid, and combinations thereof; wherein the ratio of organic acid to a mineral content in the chitin-containing biomass is between about 2:1 and about 10:1. In certain implementations of this embodiment, the method comprises a single-step. In other implementations of this embodiment, the method further comprises aging. In certain other implementations of this embodiment, the milling is performed in solid state. In other implementations of this embodiment, the milling is performed in the presence of liquid; wherein n is between about 0.2 μL/mg and about 5 μL/mg.

In other embodiments, the methods of the present technology comprise milling a chitin-containing biomass selected from any one or more of shells and cuticles of crustaceans, arthropods, insects, squids, shellfish, krill, and fungi with a mineral acid selected from hydrochloric acid and combinations thereof, wherein the ratio of mineral acid to a mineral content in the chitin-containing biomass is between about 2:1 and about 10:1. In certain implementations of this embodiment, the method comprises a single-step. In other implementations of this embodiment, the method further comprises aging. In certain other implementations of this embodiment, the milling is performed in the presence of liquid, wherein n is between about 0.2 μL/mg and about 5 μL/mg.

In other embodiments, the method of the present technology may further comprise a step of washing and filtering the chitin obtained to remove byproducts and wastes from the reaction and to neutralize the pH. Washing may be performed with water, acetone, or other known suitable solvents. The chitin obtained may further be dried under vacuum or without vacuum after washing to remove the residual solvents. The duration of drying may be any duration necessary to dry the chitin obtained. Drying may be performed at room temperatures or at any other temperature suited for drying chitin without affecting its chemical and physical properties. In one embodiment, the chitin obtained is dried at 50° C. overnight.

In certain embodiments the mass yield of chitin obtained by the methods of the present technology is at least about 2%. In other embodiments the mass yield of chitin obtained is between about 2% and about 50%. In yet other embodiments, the mass yield of chitin obtained is more than about 10%, more than about 15%, more than about 20%, more than about 25%, more than about 30%, or more than about 40%. In further embodiments, the mass yield of chitin obtained is about 2%, about 6%, about 8%, about 10%, about 12%, about 15%, about 20%, about 25%, about 30%, about 40% or about 50%.

### Properties of Chitin Obtained

Crystallinity is related to the degree of order and the crystal size of a given crystalline substance. The crystallinity index is a quantitative indication of the purity and crystalline structure of the chitin polymer obtained. Various techniques, such as X-ray diffraction (XRD), powder X-ray diffraction (pXRD), Fourier transform infrared spectroscopy (FTIR) and Raman spectroscopy may be used to measure the crystallinity index of a substance. In certain embodiments of the present technology, the crystallinity index of chitin was measured by pXRD. Generally, crystallinity indices of more than 60% are considered to indicate high grade pure chitin wherein the chitin is substantially free of minerals and proteins.

In certain embodiments, the chitin obtained by the methods of the present technology have a crystallinity index of at least about 60%. In other embodiments, the chitin obtained by the methods of the present technology have a crystallinity index of at least about 70%.

Ash content is another important parameter to be considered during the analysis of chitin. Ash is the inorganic residue remaining after water and organic matter have been removed by heating in the presence of oxidizing agents and provides a measure of total amounts of mineral within a sample. In some embodiments of the present technology, the ash content of chitin was determined by degradation of chitin samples in the presence of air and was measured by Thermogravimetric analysis (TGA). The ash content thus representing the amount of mineral oxide present in the chitin framework is an indicator of the efficiency of demineralization. A high content of ash present in chitin can negatively affect certain properties of the chitin polymer, including solubility, viscosity, and purity. Approximately 30% of ash can be generally removed from crustacean shells after demineralization, and because of its influence in the properties of chitin polymer, the ash content of high-quality grade chitin should be less than about 1%.

In certain embodiments, the ash content of the chitin obtained by the methods of the present technology is at least about 0.5%. In other embodiments, the ash content of the chitin obtained by the methods of the present technology is between about 0.5% and about 10%. In one embodiment, the ash content of chitin obtained is between about 0.5% and about 1.0%. In further embodiments, the ash content is about 0.6%, about 1.0%, about 1.5%, about 2.0%, about 3%, about 4%, or about 9%. Advantageously this further indicates that chitin obtained by the methods of the present technology maintains its chemical and physical properties even when exposed to extreme environments.

Solid char residues in TGA may also be measured and represent the amount of residual carbonaceous materials that cannot be dissociated into volatile fragments. In certain embodiments, the char content is between about 10% and about 70%.

### EXAMPLES

The examples below are given to illustrate the practice of various embodiments of the present disclosure. They are not intended to limit or define the entire scope of this disclosure.

It should be appreciated that the subject matters of this disclosure are not limited to the particular embodiments described and illustrated herein but includes all modifications and variations falling within the scope of the subject matters of this disclosure as defined in the appended claims.

### Example 1: Extraction of Chitin from Green Crab Shells

Frozen GC were received from Parks Canada and stored in the freezer at −20° C. until use. Acetic acid, hydrochloric acid, and acetone were obtained from Fisher Scientific. Citric acid and L-Ascorbic acid were purchased from Sigma-Aldrich. KOH was obtained from ACP.

The GC shells were defleshed manually by thawing in boiling water for 5 minutes. The shells were then washed by deionized (DI) water, dried overnight at room temperature and homogenized into powder with a blender. The resulting powder containing chitin, minerals and proteins was stored at −18° C. until further treatment.

Mechanochemistry was used thereafter to remove proteins and minerals from GC shells. Milling was performed using different acids (citric acid, ascorbic acid, hydrochloric acid, or acetic acid) at different ratios (2:1 to 10:1 of acid with respect to the mineral content in the shells). For example, for a ratio of 2:1 of acetic acid to mineral content of the shells, 1.0 g GC shell powder and 0.80 ml acetic acid were combined in a zirconia jar with one zirconia ball (10 mm) using a Retsch MM 400 mixer. The mixture of GC shell powder and acetic acid was then milled for 30 minutes at 30 Hz. The procedure was similar for other acids. The total reagent mass of solid in all experiments was kept to around 1.0 g.

In certain embodiments, wherein aging was used after milling, the mixture was transferred to a 10 ml beaker in a standard Tupperware glass container with a petri dish of super-saturated K₂SO₄ solution to achieve a RH of 98% in the container.

The sample was worked up by washing with 100 ml of water and filtering using a Whatman filter paper until neutral pH, followed by washing with 50 ml acetone and vacuum drying at 50° C. overnight.

### Example 2: Characterization of Chitin

Powder X-ray diffraction (pXRD) spectra was acquired using a Bruker D8 Advance X-ray diffractometer equipped with a CuKα filament, scanned with a 20 range between 5-55° with an increment of 0.02°. Chitin crystallinity was obtained by comparing the area of the peaks (reduced area) and the area of the peaks (reduced area), where crystallinity %=(reduced area)×100/(global area).

Thermogravimetric analysis (TGA) was carried out by a Q50TM from TA Instruments under nitrogen flow at a temperature range of 30 to 800° C. and a ramp rate of 10° C. min-1 in aluminum pans.

Solid-state nuclear magnetic resonance (NMR) spectra were collected on a Varian VNMRS operating at 400 MHz for the ¹³C acquisition using a 4 mm double-resonance Varian Chemagnetics T3 probe. The number of scans was 640 for each sample for a total time of 1.5 h. Each data point in the spectra was acquired by a 3 s recycle delay, 512 co-added transients and contact times between 0.06-8 ms.

Power consumption was measured using a RioRand Plug Power Meter. The power consumption was measured for the mill, hot plate and the oven while in experimental use.

### Example 3: Chitin Produced by Solvothermal Demineralization and Deproteinization of Green Crabs (the Legacy Method)

Materials were purchased, and GC shell powder was prepared as described in Example 1.

The legacy method was carried out as described in Naczk M. et al., “Compositional characteristics of green crab (Carcinus maenas)”, Food Chemistry 2004, 88 (3), 429-434, and Fulton, B. A. & Fairchild, E. A., “Nutritional analysis of whole green crab, Carcinus maenas, for application as a forage fish replacement in agrifeeds”, Sustainable Agriculture Research 2013, 2 (3), 126 (the contents of which are incorporated herein by reference). Briefly, 20 g of powdered shell was deproteinized with 400 ml of 5% KOH solution for 2 h at 100° C. with occasional mixing. After the deproteinization, the biomass was isolated using Whatman filter paper (90 mm) and washed with water until neutral pH. Subsequently, the sample was treated with 5% HCl at a ratio of 1/25 (w/v) at room temperature for 2 h with constant mixing. Finally, the product was washed by DI water to pH 7, and then with 100 ml acetone, followed by drying under vacuum at 50° C. overnight.

### Example 4: Characterization of Chitin Produced by the Legacy Method

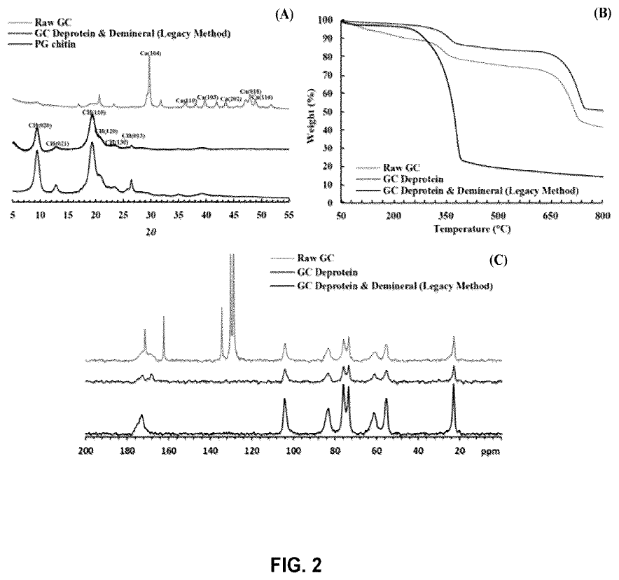

FIG. 2A shows pXRD profiles of raw GC shells, deproteinized and demineralized GC shells, and commercially available practical grade (PG) chitin. The pXRD spectrum of raw GC reveal the characteristics peaks for calcite in the region of 29 to 50, which was completely absent from the profile of chitin isolated from GC, indicating the mineral component was successfully removed from newly prepared chitin. The crystallinity index was 77.3% for the prepared chitin and 80.5% for PG chitin.

In order to analyze and quantify the residual minerals and proteins, TGA analyses of GC shells before and after treatment and that of the intermediate deproteinized product were performed (FIG. 2B). It is important to consider that the deproteinized GC shells and the chitin isolated by the legacy method does not exhibit weight loss between 15° and 250° C., in contrast to the raw GC shells where a small hump was observed. This may be indicative of residual protein in raw GC shells. This suggests that protein is not present along with chitin obtained by the legacy method. Furthermore, the absence of weight loss in the region of 600 to 800° C. for the legacy method demonstrates the complete removal of calcium carbonate. Overall, TGA demonstrates that the raw GC shells contains ˜65 w % minerals and ˜7 w % protein and ˜28% chitin on a dry-weight basis. The GC shell was high in char (14 w %). The chemical composition of the GC shells was close to those reported by the previous studies. This implies that more than 70% of GC shell needs to be removed to obtain a pure chitin product.

¹³C SS-NMR is one of the important analysis techniques to assess the purity of chitin. FIG. 2C shows the SS-NMR spectrum of raw GC shells, deproteinized shells and chitin separated from GC shells by the legacy method. The spectrum of GC shells indicates all the characteristic peaks of chitin, namely, 103 (C1), 82.5 (C4), 76 (C5), 73 (C3), 61 (C6), 55 (C2), 22 (C8) and 173 ppm carbonyl carbon in N-acetylamine. Furthermore, it shows peaks for proteins in the range of 125 to 140 ppm as confirmed by the spectrum of deproteinized shells. In addition, it reveals peaks in the region 160 to 190 corresponding to calcite and vaterite. The characteristics peaks of minerals and proteins were not detected in the chitin isolated by the legacy method, indicating its purity by the limits of ¹³C SS-NMR.

### Example 5: Extraction of Chitin by Mechanochemistry

GC shell powder prepared as described in Example 1 was milled using a Retsch MM 400 mixer mill with a 20 ml zirconia jar and one 10 mm zirconia ball for 30 minutes. Three different organic acids (citric acid, ascorbic acid, and acetic acid) and one mineral acid (hydrochloric acid) were investigated at different concentrations to find the optimal reaction conditions. The purity of the chitin obtained from each reaction was ascertained by pXRD, TGA, and ¹³C SS-NMR.

Although mechanochemical treatment of GC shells with acid was initially expected to result in the demineralization of the chitin, analysis by ¹³C SS-NMR and pXRD surprisingly showed that proteins were also removed from the GC shells during the mechanochemical treatment of GC shells with the acids used. In other words, the production of chitin from GC shells was achieved in a single step without using a basic (e.g., KOH) deproteinization step as used in the legacy method.

Furthermore, as will be described in further detail below, unlike other existing extraction methods (e.g., Zhang, J. et al., “Base-free preparation of low molecular weight chitin from crab shell”, Carbohydrate Polymers, 2018, 190, 148-155; incorporated herein by reference), the methods of the present technology were carried out with milder acids in a shorter amount of time with less energy. Since the methods of the present technology do not involve any harsh chemical environments, the chitin produced by the methods of the present technology remains intact after the separation step.

### Citric Acid

Citric acid has been used for the treatment of biomass such as chitin, cellulose and lignin as a green modifier. Since citric acid contains 3 acidic functionalities, one mole of calcium carbonate can theoretically react with 2/3 moles citric acid. However, the pKa of the third proton is ˜6.4, indicating a weak acid. Moreover, since there are proteins and other minerals in the crab shells which must be removed, the amount citric acid used was selected to be in excess to completely remove the minerals and proteins.

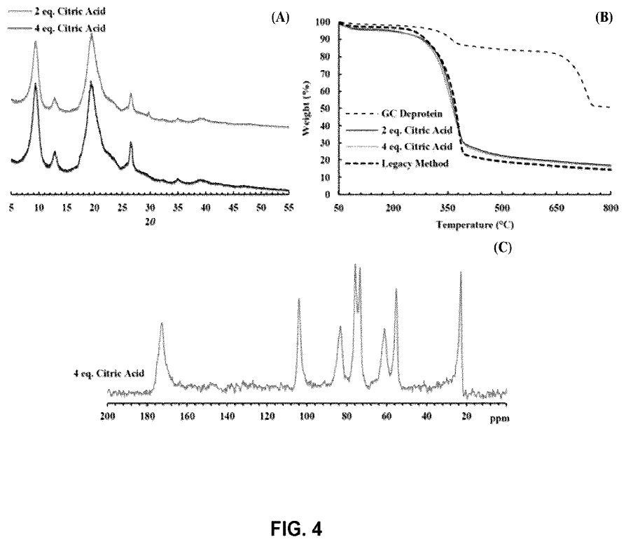

Initially, GC shell powder was subjected to 2 equivalents citric acid (ratio 2:1 acid with respect to the mineral content in the shells) in order to obtain pure chitin. The process was carried out by milling the GC shells and citric acid for 30 minutes without aging or any other post-reaction modifications. After the isolation of the product, the residual minerals were determined by pXRD and TGA. The TGA of deproteinized GC shell and the final chitin by the legacy method is shown for comparison in FIG. 4B. Although TGA showed a decomposition similar to the legacy method, pXRD showed some mineral impurities at 20 values of 30° associated with calcite. Therefore, the citric acid ratio was increased from 2 to 4 equivalents (ratio of 4:1 acid with respect to the mineral content in the shells) in order to achieve complete demineralization and deproteinization.

The pXRD of chitin separated from GC shells by 4 equivalents of citric acid (FIG. 4A) revealed the prominent crystalline peaks associated with chitin, at 20 values of 9.57 (020), 12.95 (021), 19.61 (110), 21.15 (120), 23.43 (130), and 26.58 (013). The other peaks correlated with calcite were not observed for 4 equivalents of citric acid suggesting that it is essentially pure by the limits of pXRD. The pXRD and TGA patterns of chitin obtained by milling are in good agreement with those of chitin obtained by the legacy method suggesting that the chitin obtained is free from minerals. According to FIG. 4B, the final char yield at 800° C. was 16 w % which was close to that of the legacy method (14 w %). The crystallinity index of the chitin was 76.3% for 4 equivalents citric acid. The ¹³C SS-NMR spectrum is in accordance with the pure chitin obtained by the legacy method (FIG. 4C).

### Ascorbic Acid

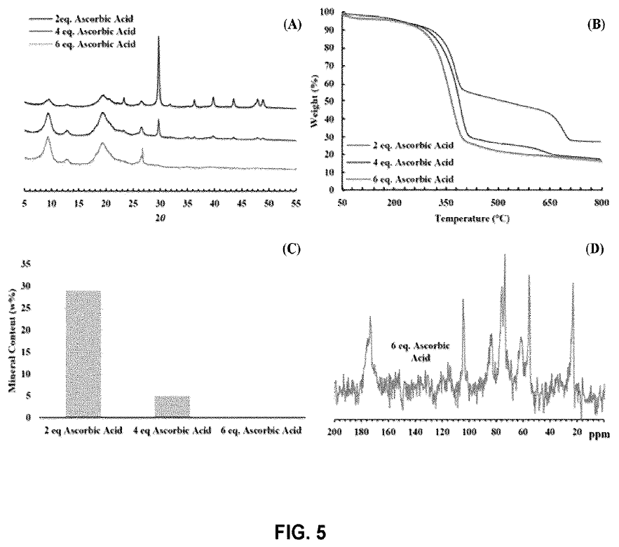

FIGS. 5A-5D presents the results for milling of GC shell powder with ascorbic acid at different ratio of acid to mineral content of shells. Milling with 2 equivalents (ratio of 2:1) of ascorbic acid, removed 55% of minerals as indicated by TGA (FIG. 5B). As ascorbic acid ratio increased from 2 equivalents to 4 equivalents (ratio 4:1), the mineral content sharply decreased from 29 to 5 wt % (FIG. 5C). By using 6 equivalents of ascorbic acid (ratio 6:1), the residual calcium carbonate was completely removed from the shells as indicated by pXRD, TGA and ¹³C SS-NMR (FIG. 5D). The char content of the chitin obtained by this method was 16%. Furthermore, the crystallinity index of the chitin was 70.2%. In comparison to citric acid, more ascorbic acid was required to produce chitin while the yield of the reaction was lower with ascorbic acid (2.4 wt %) than with citric acid (7.2 wt %).

### Hydrochloric Acid

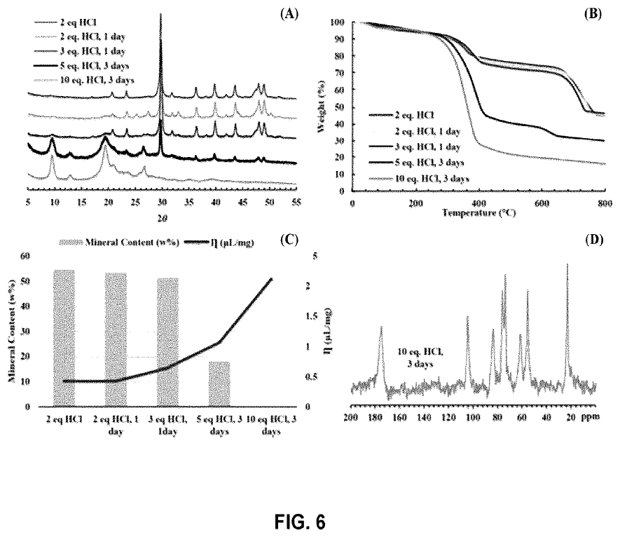

Initial attempts at milling the shells with 2 equivalents HCl (ratio 2:1) resulted in minor demineralization (57% mineral content) when the samples were milled 30 minutes without aging (FIGS. 6A and 6C). To enhance the removal of minerals, aging at RH of 98% and 50° C. was used. However, aging with 2 equivalents of HCl for 1 day did not substantially improve the demineralization (56% remaining minerals).

To further improve the demineralization, increasing the aging time combined with increasing HCl ratio was attempted. Complete demineralization was achieved by using 10 equivalences of HCl (ratio 10:1) and 3 days of aging, which was confirmed by the lack of mineral peaks between 30° to 55° in pXRD spectra and the one-step decomposition in TGA (FIGS. 6A and 6B). Further characterization was carried out by ¹³C SS-NMR, confirming the structure of chitin (FIG. 6D). The crystallinity index of the chitin obtained by this method was found to be 61.4%, which was lower than those of citric and ascorbic acid. The overall yield of chitin production using 10 equivalents of HCl was 6.4%.

In these embodiments liquid HCl was used to control demineralization in solid-state. About 2-10 equivalents of HCl was used in for liquid assisted grinding, which equated to an n ranged from 0.42 to 2.12 μL/mg. As best seen in FIG. 6C, successful demineralization with HCl occurred in slurry conditions followed by aging.

### Acetic Acid

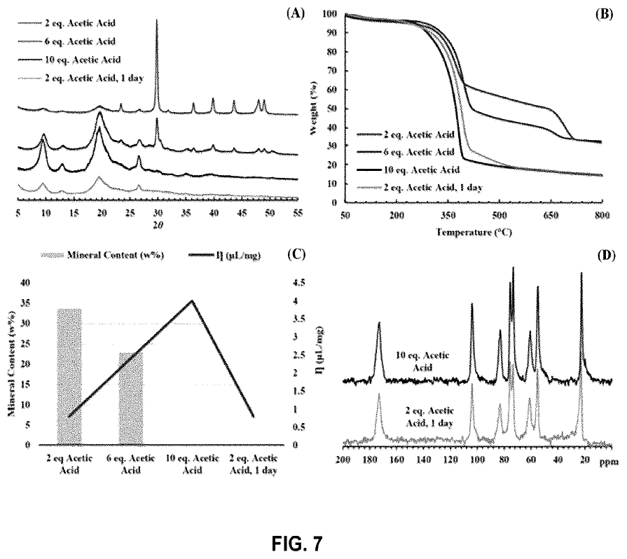

The effect of acid to shells ratio (2:1, 6:1, 10:1 acid to minerals) was investigated by milling the GC shells with acetic acid for 30 minutes. The method used liquid assisted grinding. FIGS. 7A and 7B show pXRD and TGA characterization of the obtained chitin. Milling the GC shells with 2 equivalents of acetic acid did not achieve a proper demineralization as confirmed by the presence of mineral peaks between 30° to 55° in pXRD. The mineral content of the product was 33.8 wt %. The comparison between the mineral removal efficiency and η values of acetic acid at different conditions are presented in FIG. 7C. The results show that the total minerals fractions were 33.8, 23.0 and 0 wt % for 2 eq. (η=0.8), 6 eq. (η=2.4) and 10 eq. (η=4.0) of acetic acid when milling without aging was adopted. This shows that milling with 10 equivalents of acetic acid in the slurry conditions results in a successful demineralization.

The effect of aging at 50° C. and 98% RH for 1 day was further explored. As seen in FIG. 7A milling with 2 equivalents of acetic acid followed by aging successfully removed the minerals as observed by pXRD. The crystallinity index of the product was 51.4% which was lower compared to 10 equivalent acetic acid (70.4%), indicating that aging may result in the depolymerization of the chitin chains. The purity of the chitin was further verified by TGA and ¹³C SS-NMR (FIGS. 7B and 7D). The results demonstrate that while increasing the acid ratio is required for effective demineralization and deproteinization of chitin, aging under humidity plays an important role in the reduction of acid ratios. Additionally, the effectiveness of acetic acid in removing the minerals from the shells was higher than that of HCl and ascorbic acid when the sample was aged for 1 day.

### Example 6: Additional Organic Acids for Extraction of Chitin from Chitin-Containing Biomass

To further optimize the methods of the present technology, other organic acids were tested. Specifically, L-malic, succinic, and salicylic acids were investigated for the extraction of chitin.

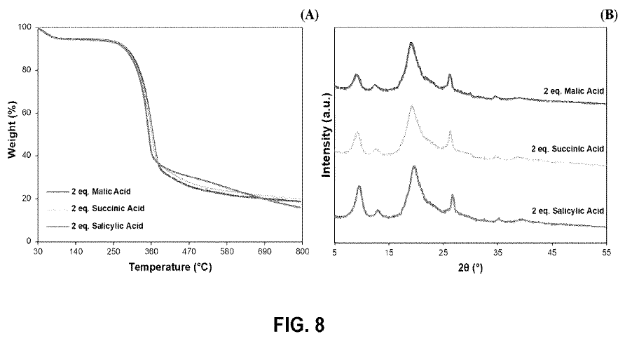

Chitin extraction was conducted by mechanochemistry as described above. Specifically, chitin was extracted form GC shells employing 2 equivalents of L-malic, succinic, and salicylic acids. The results shown in FIGS. 8A and 8B, and summarized in Table 1, indicate complete demineralization and deproteinization of the GC shells.

TABLE 1
Results obtained during characterization of chitin extracted from
GC shells using different organic acids and 30 min milling time.

| Entry | Acid (g)^{a} | Yield (%)^{b} | Crystallinity (%)^{c} | Char (%)^{d} | Ash (%)^{d} |
|---|---|---|---|---|---|
| 1 | Citric Acid (4 eq., 1.34 g) | 7.2 | 76.3 | 16.0 | 2.0 ± 0.3 |
| 2 | Ascorbic Acid (6 eq., 1.84 g) | 2.4 | 70.2 | 16.0 | 2.1 ± 0.2 |
| 3 | L-malic Acid (2 eq., 0.47 g) | 16.1 ± 2.4 | 65.4 ± 2.0 | 18.7 | 1.6 ± 0.6 |
| 4 | Succinic Acid (2 eq., 0.41 g) | 10.7 ± 0.1 | 69.0 ± 0.4 | 20.3 | 1.8 ± 0.2 |
| 5 | Salicylic Acid (2 eq., 0.48 g) | 13.5 ± 1.3 | 67.5 ± 1.0 | 16.0 | 0.9 ± 0.1 |

^{a}Calculated in respect to the calcium carbonate (CaCO3) content in the shells (65%);
^{b}Calculated considering the mass of GC shells used during extraction (250 mg);
^{c}Determined via Power X-Ray Diffraction (PXRD);
^{d}Determined via Thermogravimetric Analysis (TGA).

In comparison to the values obtained using citric and ascorbic acids (Table 1, Entries 1 and 2), a slightly higher char content (19%) and lower crystallinity index values (65%) were observed for chitin extracted after milling with L-malic acid (Table 1, Entry 3). Regarding reaction efficiency, yields of chitin after extraction with malic acid (16.1%) are about 2 and 7 times higher than the ones obtained using citric and ascorbic acid, respectively. Chitin after extraction with succinic acid shows an increased crystallinity index (69%), but higher char content (20%) in comparison to the analogue extracted using L-malic acid (Table 1, Entry 4). Nevertheless, chitin yields of 10.7% are still obtained using only 400 mg of organic acid. Crystallinity index values remain similar (68%), but yields are increased to 13.5% and char values are decreased to 16% after reaction of GC shells with salicylic acid (Table 1, Entry 5). Although the material obtained is slightly less crystalline, the extraction employing L-malic, succinic, and salicylic acids uses about 70% less reagents than the methods using citric and ascorbic acids, and also allows the achievement of higher yields of chitin (11-16%) directly from GC shells.

As seen in Table 1, about 38% of ash could be removed from the GC shells and the highest ash content observed for the chitin polymer extracted from GC shells was 2.1% (Table 1, Entry 2). Therefore, the methods disclosed herein produces high-quality chitin, which maintains its chemical and physical properties even when exposed to extreme environments.

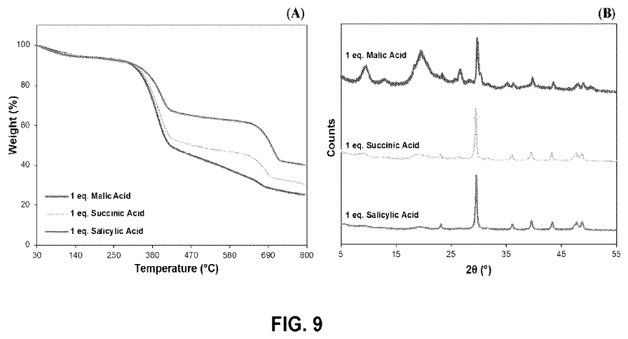

To further decrease the quantity of reagents required and reduce costs related to the neutralization of acidic waste generated, chitin extraction was attempted using only 1 equivalent of the proposed organic acids (FIGS. 9A and 9B). However, the results demonstrated that a significant amount of minerals were still present in chitin samples (>15%), as indicated by the weight loss after 600° C. in TGA (FIG. 9A) and the peaks of CaCO₃ after 30° in PXRD analysis (FIG. 9B).

With the objective of using even milder reaction conditions and reducing energy consumption in the method of the present technology, lower milling times (10 min) were explored for the extraction of chitin. As best seen in Table 2, using citric and ascorbic acid (Table 2, Entries 1 and 2), a decrease in the milling time slightly decreases polymer crystallinity but increases the yields of chitin extracted, thus reaching a value of 25.3% for salicylic acid (Table 1, Entry 5). The amount of char and ash present in the samples milled for 10 min (Table 2) is also higher in comparison to the chitin extracted after 30 min (Table 1), which suggests a more effective demineralization of GC shell samples after longer processing times.

TABLE 2
Results obtained during characterization of chitin extracted from
GC shells using different organic acids and 10 min milling time.

| Entry | Acid (g)^{a} | Yield (%)^{b} | Crystallinity (%)^{c} | Char (%)^{d} | Ash (%)^{d} |
|---|---|---|---|---|---|
| 1 | Citric Acid (4 eq., 1.34 g) | 24.0 | 71.3 | 18.2 | 6.8 ± 1.4 |
| 2 | Ascorbic Acid (10 eq., 3.08 g) | 9.1 | 72.2 | 69.8 | 2.2 ± 0.7 |
| 3 | L-malic Acid (2 eq., 0.47 g) | 16.8 ± 1.1 | 62.2 ± 0.2 | 22.8 | 2.0 ± 0.6 |
| 4 | Succinic Acid (2 eq., 0.41 g) | 12.2 ± 1.0 | 66.3 ± 3.3 | 17.4 | 2.3 ± 0.5 |
| 5 | Salicylic Acid (2 eq., 0.48 g) | 25.3 ± 0.3 | 66.9 ± 2.6 | 19.3 | 2.1 ± 0.4 |

^{a}Calculated in respect to CaCO₃ content in the shells (65%).
^{b}Calculated considering the mass of GC shells used during extraction (250 mg).
^{c}Determined via PXRD.
^{d}Determined via TGA.

Using 400 mg of L-malic, succinic, or salicylic acids, high-quality grade chitin with low ash content (<2%), good crystallinity (>60%), and yields higher than 10% can be obtained from GC shells after 30 min of ball milling. Optimum reaction conditions include the use 2 equivalents of salicylic acid and 30 min processing time, in which the lowest ash content (0.9%) is obtained with good yields (13.5%). Lower processing times could further improve the yields of chitin extracted, at the cost of polymer quality (i.e. increased ash content).

### Example 7: Scalability

The methods of the present technology were modified such as to start with 40 g of green crab shells instead of 1 g. Milling was performed using a large-scale blender. High yields and a high purity of chitin were obtained as disclosed above.

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein.

It should be appreciated that the present technology is not limited to the particular embodiments described and illustrated herein but includes all modifications and variations falling within the scope of the present technology as defined in the appended claims.

All references cited in this specification, and their references, are incorporated by reference herein in their entirety where appropriate for teachings of additional or alternative details, features, and/or technical background.

What is claimed is:

1. A method of extraction of chitin from a chitin-containing biomass comprising:
milling the chitin-containing biomass with an acid to obtain chitin,
wherein the chitin obtained by the milling step is demineralized and deproteinized.

2. The method of claim 1, wherein the acid is an organic acid.

3. The method of claim 2, wherein the organic acid is selected from citric acid, ascorbic acid, acetic acid, L-malic acid, succinic acid, salicylic acid, L-lactic acid, formic acid, benzoic acid, and glutaric acid, and combinations thereof.

4. The method of claim 1, wherein the acid is a mineral acid.

5. The method of claim 4, wherein the mineral acid is selected from hydrochloric acid, phosphoric acid, sulfuric acid, perchloric acid, and nitric acid, and combinations thereof.

6. The method of any one of claims 1 to 5, wherein the chitin-containing biomass is selected from a shell and a cuticle of a crustacean, an arthropod, an insect, a squid, a shellfish, krill, and a fungus, and combinations thereof.

7. The method of claim 6, wherein the crustacean shells are selected from shrimp shells, crab shells, and lobster shells, and combinations thereof.

8. The method of claim 7, wherein the crab shells are selected from Green Crab shells and Snow Crab shells, and combinations thereof.

9. The method of any one of claims 1 to 8, wherein a ratio of acid with respect to a mineral content of the chitin-containing biomass is between about 2:1 and about 10:1.

10. The method of any one of claims 1 to 9, wherein the milling comprises using any one or more of a mixer mill, a ball mill, a planetary mill, a jar with at least one ball, a food processor, a blender, a vortex, a rapid mixer, an extruder, and an acoustic mixer.

11. The method of any one of claims 1 to 10, wherein the milling is performed for about 5 minutes to about 60 minutes.

12. The method of claim 11, wherein the milling is performed for about 30 minutes.

13. The method of claim 11, wherein the milling is performed for about 10 minutes.

14. The method of any one of claims 1 to 13, wherein the milling is performed in solid state.

15. The method of any one of claims 1 to 14, wherein the milling is performed in the absence of water.

16. The method of any one of claims 1 to 13, wherein the milling step is performed in the presence of a liquid.

17. The method of claim 16, wherein a ratio n of the liquid relative to a weight of the chitin-containing biomass is between about 0.2 μL/mg and about 5 μL/mg.

18. The method of any one of claims 1 to 17, further comprising aging the chitin-containing biomass with the acid after milling.

19. The method of claim 18, wherein the aging comprises aging in a humidified chamber.

20. The method of claim 19, wherein the aging is performed at a relative humidity of about 98%.

21. The method of any one of claims 18 to 20, wherein the aging is performed at a temperature of between about 20° C. and about 100° C.

22. The method of claim 21, wherein the aging is performed at a temperature of about 50° C.

23. The method of any one of claims 18 to 22, wherein the aging is performed for about 12 hours to about 6 days.

24. The method of claim 23, wherein the aging is performed for about 1 day.

25. The method of claim 23, wherein the aging is performed for about 3 days.

26. The method of any one of claims 1 to 17, wherein the method comprises a single step.

27. The method of any one of claims 1 to 17, wherein the method consists of milling the chitin-containing biomass with the acid to obtain the chitin.

28. The method of any one of claims 1 to 27, wherein a crystallinity index of the chitin obtained is at least about 60%.

29. The method of claim 28, wherein the crystallinity index of the chitin obtained is at least about 70%.

30. The method of any one of claims 1 to 29, wherein the chitin obtained is substantially free of minerals.

31. The method of any one of claims 1 to 30, wherein the chitin obtained is substantially free of proteins.

32. The method of any one of claims 1 to 31, wherein the chitin obtained is intact.

33. The method of any one of claims 1 to 32, wherein a mass yield of the chitin obtained is between about 2% and 50%.

34. The method of claim 33, wherein the mass yield is at least about 25%.

35. The method of any one of claims 1 to 34, wherein an ash content of the chitin obtained is between about 0.5% and about 10%.

36. The method of claim 35, wherein the ash content is between about 0.5% and about 1%.

37. A method of producing deproteinized and demineralized chitin comprising milling a chitin-containing biomass with an acid.

38. The method of claim 37, wherein the acid is an organic acid.

39. The method of claim 38, wherein the organic acid is selected from citric acid, ascorbic acid, acetic acid, L-malic acid, succinic acid, salicylic acid, L-lactic acid, formic acid, benzoic acid, and glutaric acid, and combinations thereof.

40. The method of claim 37, wherein the acid is a mineral acid.

41. The method of claim 40, wherein the mineral acid is selected from hydrochloric acid, phosphoric acid, sulfuric acid, perchloric acid, and nitric acid, and combinations thereof.

42. The method of any one of claims 37 to 41, wherein the chitin-containing biomass is selected from a shell and a cuticle of a crustacean, an arthropod, an insect, a squid, a shellfish, krill, and a fungus, and combinations thereof.

43. The method of claim 42, wherein the crustacean shells are selected from shrimp shells, crab shells, and lobster shells, and combinations thereof.

44. The method of claim 43, wherein the crab shells are selected from Green Crab shells, and Snow Crab shells, and combinations thereof.

45. The method of any one of claims 37 to 44, wherein a ratio of acid with respect to a mineral content in the chitin-containing biomass is between about 2:1 and about 10:1.

46. The method of any one of claims 37 to 45, wherein the milling comprises using any one or more of a mixer mill, a ball mill, a planetary mill, a jar with at least one ball, a food processor, a blender, a vortex, a rapid mixer, an extruder, and an acoustic mixer.

47. The method of any one of claims 37 to 46, wherein the milling is performed for about 5 minutes to about 60 minutes.

48. The method of claim 47, wherein the milling is performed for about 30 minutes.

49. The method of claim 47, wherein the milling is performed for about 10 minutes.

50. The method of any one of claims 37 to 49, wherein the milling is performed in solid state.

51. The method of any one of claims 37 to 50, wherein the milling is performed in the absence of water.

52. The method of any one of claims 37 to 49, wherein the milling step is performed in the presence of a liquid.

53. The method of claim 52, wherein a ratio n of the liquid relative to a weight of chitin-containing biomass is between about 0.2 μL/mg and about 5 μL/mg.

54. The method of any one of claims 37 to 53, further comprising aging the chitin-containing biomass with the acid after milling.

55. The method of claim 54, wherein the aging comprises aging in a humidified chamber.

56. The method of claim 55, wherein the aging is performed at a relative humidity of about 98%.

57. The method of any one of claims 54 to 56, wherein the aging is performed at a temperature of between about 20° C. and about 100° C.

58. The method of claim 57, wherein the aging is performed at a temperature of about 50° C.

59. The method of any one of claims 54 to 58, wherein the aging is performed for about 12 hours to about 6 days.

60. The method of claim 59, wherein the aging is performed for about 1 day.

61. The method of claim 59, wherein the aging is performed for about 3 days.

62. The method of any one of claims 37 to 53, wherein the method comprises a single step.

63. The method of any one of claims 37 to 53, wherein the method consists of milling a chitin-containing biomass with an acid.

64. The method of any one of claims 37 to 63, wherein a crystallinity index of the deproteinized and demineralized chitin is at least about 60%.

65. The method of claim 63, wherein the crystallinity index is at least about 70%.

66. The method of any one of claims 37 to 65, wherein the deproteinized and demineralized chitin is substantially free of minerals.

67. The method of any one of claims 37 to 66, wherein the deproteinized and demineralized chitin is substantially free of protein.

68. The method of any one of claims 37 to 67, wherein the deproteinized and demineralized chitin is intact.

69. The method of any one of claims 37 to 68, wherein the mass yield of the deproteinized and demineralized chitin is between about 2% and 50%.

70. The method of claim 69, wherein the mass yield is at least about 25%.

71. The method of any one of claims 37 to 70, wherein an ash content of the deproteinized and demineralized chitin is between about 0.5% and about 10%.

72. The method of claim 71, wherein the ash content is between about 0.5% and about 1%.
